(19) United States
(12) Patent Application Publication
(10) Pub. No.: US 2017/0118526 A1
(43) Pub. Date: Apr. 27, 2017

(54) SYSTEMS AND METHODS FOR INDICATING COMMERCIAL BREAK IN PROGRAM GUIDE

(71) Applicant: ROVI GUIDES, INC., Santa Clara, CA (US)

(72) Inventors: Kevin Tanji, Los Angeles, CA (US); Walter R. Klappert, Los Angeles, CA (US)

(21) Appl. No.: 14/923,773

(22) Filed: Oct. 27, 2015

(51) Int. Cl. H04N 21/488; H04N 21/81; H04N 21/439; H04N 21/435; H04N 21/482; H04N 21/442

(52) U.S. Cl. CPC H04N 21/4882; H04N 21/4821; H04N 21/44204; H04N 21/4394; H04N 21/435; H04N 21/812

(57) ABSTRACT

Methods and systems for indicating commercial breaks in program guides are provided. A simultaneous display is generated of a first listing for a first media asset and a second listing for a second media asset. A determination is made of a first length of time corresponding to a first amount of advertisements in the first media asset, and a second length of time corresponding to a second amount of advertisements in the second media asset. A simultaneous display is generated of a first indicator adjacent to the first length of time with the first listing, and a second indicator adjacent to the second length of time with the second listing.

### BACKGROUND

Media assets are often preceded or interrupted by advertisements for various products and services. Users may find such advertisements to be a flaw in their viewing experience, and may wish to avoid watching these advertisements. Doing so will allow them to have a quicker and more continuous viewing experience, thus increasing their enjoyment of the media assets.

### SUMMARY

Embodiments described herein allow users to easily determine at a glance whether they will have to watch advertisements, and for what amount of time, if they access a media asset. Hence, the user is prevented from having to manually access multiple media assets to find one without an associated advertisement. Multiple indicators can be simultaneously presented to users in program listings to allow a user to compare associated advertisement times and determine which media asset to access.

Accordingly, methods and systems for indicating commercial breaks in program guides are described. In some aspects, the method may include generating for simultaneous display a first listing for a first media asset and a second listing for a second media asset. The method may include determining a first length of time corresponding to a first amount of advertisements in the first media asset, and a second length of time corresponding to a second amount of advertisements in the second media asset. The method may include generating for simultaneous display a first indicator adjacent to the first length of time with the first listing, and a second indicator adjacent to the second length of time with the second listing. For example, an electronic program guide may be displayed, wherein each program listing is associated with an indicator of the length of advertisements remaining in the associated media asset.

Embodiments discussed herein may continuously update the indicators for advertisement times to allow the user to determine in real-time the length of advertisements associated with media assets. In some embodiments, the method may include retrieving a previous update time of the first indicator and a current time, determining if a difference between the previous update time and the current time is more than a threshold difference, and updating the first indicator if the difference is more than the threshold difference.

Embodiments discussed herein may present indicators that not only indicate the length of advertisements associated with media assets, but also provide information about whether the advertisements can be skipped, and whether the advertisements all appear before the media asset as “pre-roll” advertisements, or whether they appear in advertisement breaks during the media asset. In some embodiments, the method may include determining whether the advertisements in the first media asset can be skipped, and updating the first indicator to indicate whether the advertisements in the first media asset can be skipped. In some embodiments, the method may include determining whether the advertisements in the first media asset appear before or during the first media asset, and updating the first indicator to indicate whether the advertisements in the first media asset appear before or during the first media asset.

In some embodiments, the method may include determining the first length of time by detecting a beginning and end of playback of advertisements in the first media asset, and calculating a difference between the beginning and end of the playback of advertisements. In some embodiments, determining the beginning and end of playback may include accessing the first media asset, determining an average volume level of the first media asset, comparing the average volume level to the threshold volume level, and detecting an advertisement if the average volume level is above the threshold volume level but detecting a media asset if the average volume level is below the threshold volume level.

Embodiments discussed herein may prevent users from selecting media assets with associated advertisements to ensure an advertisement-free experience for users. In some embodiments, the method may include ignoring user selection of media asset listings corresponding to media assets in which advertisements are being displayed. In some embodiments, the interactive media guide may receive a user selection of the first listing, retrieving a current time, determining that the current time is during a playback of advertisements in the first media asset, and ignoring the user selection in response to the determination.

Embodiments discussed herein may provide indicators associated with future advertisements to be displayed during media assets as well, to allow users to plan their viewing in advance. In some embodiments, the method may include indicating future advertisements by retrieving, from a database listing a plurality of metadata associated with a plurality of media assets, metadata associated with the first media asset. The method may further include searching the metadata for start times of future advertisements in the first media asset, determining whether the future advertisements will begin within a threshold time of a current time, and updating the first indicator to indicate an advertisement will be beginning if the future advertisements will begin within a threshold time of the current time.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented.

### BRIEF DESCRIPTION OF THE DRAWINGS

The above and other objects and advantages of the disclosure will be apparent upon consideration of the following detailed description, taken in conjunction with the accompanying drawings, in which life reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative example of a display screen with indicators generated by a media guidance application in accordance with some embodiments of the disclosure;

FIG. 6 shows another illustrative example of a display screen with indicators generated by a media guidance application in accordance with some embodiments of the disclosure;

FIG. 7 shows an illustrative process for generating media asset listings with indicators in accordance with some embodiments of the disclosure;

FIG. 8 shows illustrative pseudocode for executing a process for generating media asset listings with indicators in accordance with some embodiments of the disclosure;

FIG. 9 shows an illustrative process for determining lengths of advertisements in accordance with some embodiments of the disclosure;

FIG. 10 shows illustrative pseudocode for executing a process for determining lengths of advertisements in accordance with some embodiments of the disclosure; and

FIG. 11 shows an illustrative process for indicating commercial breaks in program guides.

### DETAILED DESCRIPTION

Methods and systems for indicating commercial breaks in program guides are described. These methods may be performed by an interactive media guide implemented on a user device as described below. As referred to herein, “interactive media guide” refers to a media guidance application as described below. As referred to herein, “commercial breaks” refer to a single commercial or series of commercials that precedes, is included in, or ends a media asset. Commercial breaks may interrupt the media asset they appear in. “Commercial breaks” and “advertisement breaks” are used interchangeably in this application. “Commercials” and “advertisements” are used interchangeably in this application.

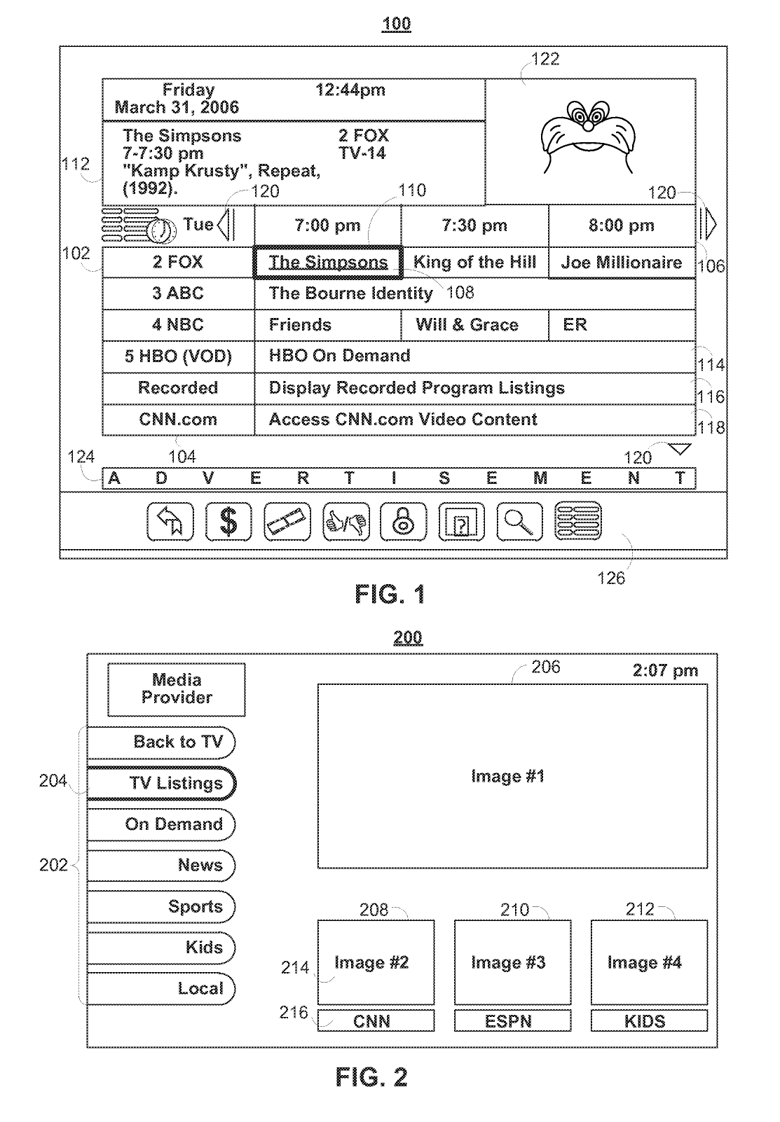

In some embodiments, the method may include generating for simultaneous display a first listing for a first media asset and a second listing for a second media asset. These listings may be displayed as part of an electronic program guide as described in relation to FIGS. 1 and 2. “Program listings” and “media asset listings” are referred to interchangeably in this application. For example, program listings for television programs “Dance Moms” and “Dancing with the Stars” may be displayed in an electronic program guide.

In some embodiments, the method may include determining a first length of time corresponding to a first amount of advertisements in the first media asset, and a second length of time corresponding to a second amount of advertisements in the second media asset. For example, the interactive media guide may access metadata associated with two television programs “Dance Moms” and “Dancing with the Stars.” The metadata associated with each television program may list the start time, end time, and length of each advertisement in the television program. The interactive media guide may determine that a current commercial break in “Dance Moms” has two minutes of advertisements remaining, while “Dancing with the Stars” will be displaying three minutes of advertisements in one minute.

In some embodiments, the method may include generating for simultaneous display a first indicator adjacent to the first length of time with the first listing, and a second indicator adjacent to the second length of time with the second listing. For example, the interactive media guide may generate for display a line with a length corresponding to two minutes with the program listing for “Dance Moms” to indicate that “Dance Moms” has two minutes of advertisements remaining. The indicator may gradually shrink in length as the length of advertisements remaining decreases. The interactive media guide may also generate for display a line with a length corresponding to three minutes of advertisements with the program listing for “Dancing with the Stars.” This indicator may be associated with text, or be displayed in a different shape or color from the indicator for “Dance Moms” to indicate that it is providing information about future advertisements.

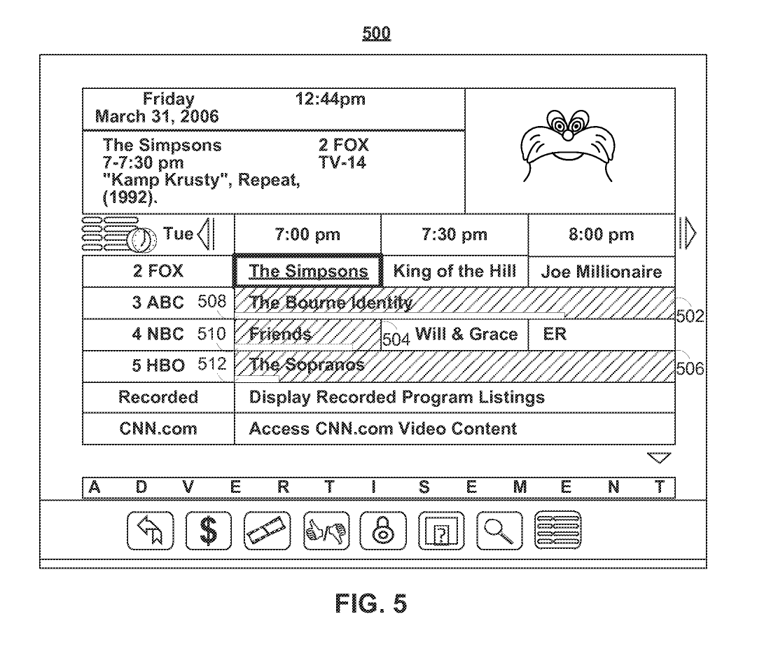

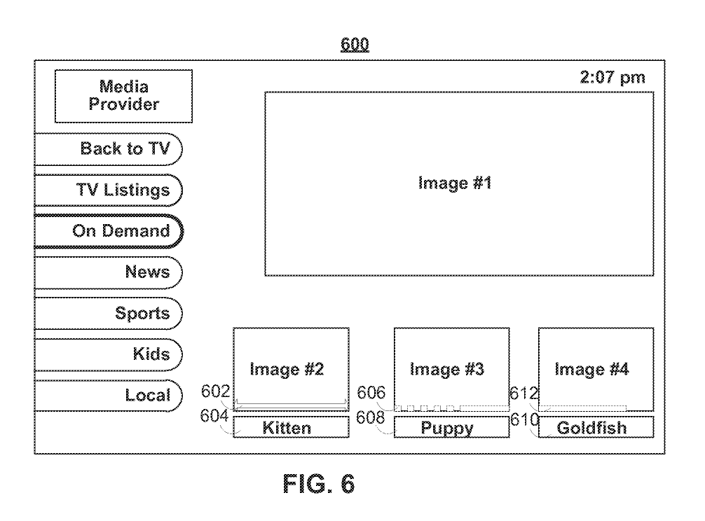

The indicators may be generated as part of electronic program guides, as described in relation to FIGS. 5 and 6. As referred to herein, an indicator refers to a shape, text, animation, sound, vibration, or any combination of these that provides information to users about advertisements. Indicators may be distinguished from each other based on their properties. For example, advertisement indicators for currently displayed advertisements may be displayed in yellow, while advertisement indicators for future advertisements may be displayed in green.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

FIGS. 1-2 and 5-6 show illustrative display screens that may be used to provide media guidance data. The display screens shown in FIGS. 1-2 and 5-6 may be implemented on any suitable user equipment device or platform. While the displays of FIGS. 1-2 and 5-6 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

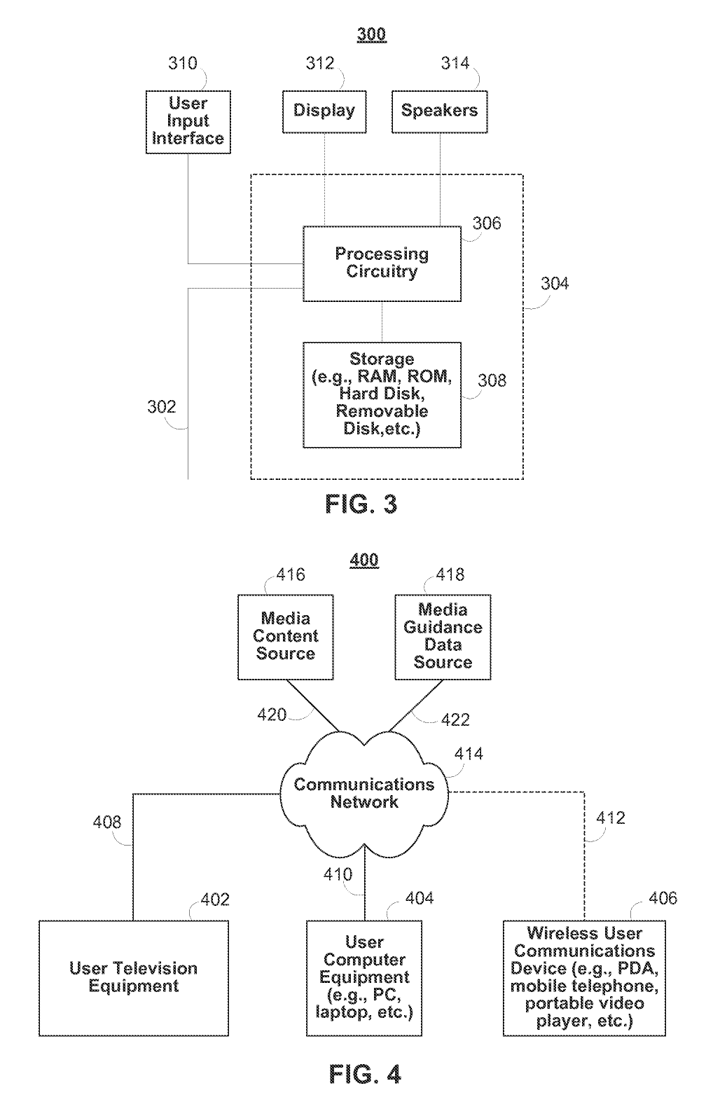

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

FIG. 5 shows an exemplary electronic program guide that may be generated by the interactive media guide on display 312. Electronic program guide 500 may be similar to the electronic program guide discussed in relation to FIG. 1.

Electronic program guide 500 shows program listings for broadcast media assets. The media assets include “The Bourne Identity” 502, “Friends” 504, and “The Sopranos” 506. Each media asset may include advertisements. For example, each media asset may include advertisement breaks, wherein each break is a period of time in which multiple consecutive advertisements are generated for display by control circuitry 304 on display 312. In some embodiments, each media asset may also include advertisements displayed simultaneously with the media asset, such as banner ads overlaid on top of the broadcast media asset. Although broadcast media assets are discussed here, it is understood electronic program guide 500 could include any type of media asset, such as pay-per-view media assets or on-demand media assets.

Media asset “The Bourne Identity” 502 includes an indicator 508 that indicates the length of the advertisements associated with the media asset. In some embodiments, the interactive media guide may only display indicators associated with media assets if advertisements are currently playing in the associated media assets. For example, control circuitry 304 may determine that advertisements are currently being displayed in an advertisement break in media asset “The Bourne Identity” 502. In response to this determination, control circuitry 304 may use display 312 to generate for display indicator 508.

In some embodiments, the interactive media guide may display indicators for future advertisements. For example, control circuitry 304 may determine that advertisements will be displayed in the future on channel 2 FOX currently displaying media asset “The Bourne Identity” 502. In response to this determination, control circuitry 304 may use display 312 to generate for display indicator 508. In some embodiments, the interactive media guide may only generate for display indicators for future advertisements if the future advertisements will be displayed within a threshold amount of time from the current time. User input interface 310 may receive user preferences defining the threshold amount of time to be used. For example, control circuitry 304 may determine that advertisements will be displayed on channel 2 FOX currently displaying media asset “The Bourne Identity” 502 in five minutes.

User input interface 310 may previously have received a user input that an indicator should only be generated for display for future advertisements if the future advertisements will be displayed within one minute of the current time. Control circuitry 304 may determine that the advertisements will be displayed in an amount of time greater than the user input threshold of one minute. Hence, control circuitry 304 may not generate for display on display 312 indicator 508. In some embodiments, interactive media guide may use a threshold amount of time if the user does not input an amount of time to be used for this determination.

In some embodiments, the interactive media guide may disable selection of media assets that have advertisements currently being displayed in them. For example, control circuitry 304 may determine that media asset “The Bourne Identity” 502 is currently displaying advertisements. In response to the determination, control circuitry 304 may disable user selection of media asset “The Bourne Identity” 502 in electronic program guide 500. In some embodiments, control circuitry 304 may disable highlighting of media assets that have advertisements currently being displayed in them. For example, control circuitry 304 may determine that media asset “The Bourne Identity” 502 is currently displaying advertisements. In response to the determination, control circuitry 304 may not allow a user to highlight the media asset listing corresponding to media asset “The Bourne Identity” 502. In some embodiments, control circuitry may change a visual appearance of media asset listings which cannot be selected or highlighted. For example, control circuitry 304 may shade the background of the media asset listings for media assets “The Bourne Identity” 502, “Friends” 504, and “The Sopranos” 506 to indicate that control circuitry 304 has disabled selection of these media asset listings.

Interactive media guide may generate for display indicators associated with media asset listings. For example, control circuitry 304 may generate for display indicators 508, 510, and 512 associated with media asset listings for media assets “The Bourne Identity” 502, “Friends” 504, and “The Sopranos” 506. The interactive media guide may allow a user to edit preferences to enable or disable these indicators.

Length of indicator 508 may be associated with the length of advertisement playing in a media asset. In some embodiments, the length of indicator 508 may correspond to an exact value of time. For example, control circuitry 304 may generate for display indicator 508 to represent two minutes. This would indicate that two minutes of advertisements are left to be displayed before media asset “The Bourne Identity” 502 is displayed. Control circuitry 304 may generate for display indicator 512 to be shorter than indicator 508. Indicator 512 may indicate that only 30 seconds of advertisements are left to be displayed before media asset “The Sopranos” 506 is displayed. Hence, media asset “The Bourne Identity” 502 has more advertisements left to be displayed than media asset “The Sopranos” 506.

In some embodiments, the length of indicator 508 may correspond to a relative value of time. For example, control circuitry 304 may generate for display indicator 508 to take up three-fourths of the available horizontal space in the media asset listing for media asset “The Bourne Identity” 508. This may represent that three-fourths of the advertisements in the current advertisement break of media asset “The Bourne Identity” 502 have not yet been displayed. Control circuitry 304 may also generate for display indicator 508 to take up three-fourths of the available horizontal space in the media asset listing for media asset “Friends” 506. Hence, control circuitry 304 may use indicators 508 and 510 to indicate that three-fourths of their respective advertisement breaks have not yet been displayed for these media assets.

In some embodiments, indicators may be associated with a length of time of a future advertisement break. For example, control circuitry 304 may generate for display indicator 508 to represent that a two minute advertisement break will soon occur on channel 2 FOX. In some embodiments, control circuitry 304 may generate for display an indicator indicating the amount of time left until the next commercial break begins. In some embodiments, control circuitry 304 may generate for display an indicator indicating the amount of time the next advertisement will be displayed for, and not update the length of this advertisement until the next advertisement is generated for display.

In some embodiments, control circuitry 304 may generate for display indicators for only media asset listings corresponding to media assets in which advertisements are currently displayed. For example, control circuitry 304 may not generate for display an advertisement for the media asset “The Simpsons” because no advertisement is currently being displayed in the media asset. Control circuitry 304 may generate for display indicator 508 for media asset “The Bourne Identity” 502 because an advertisement is currently being displayed in the media asset.

In some embodiments, the interactive media guide may generate indicators with the same maximum length as their media asset listing. For example, control circuitry 304 may generate for display indicator 510 such that its maximum length is the same as the width of the media asset listing for media asset “Friends” 504. In some embodiments, the interactive media guide may generate indicators with a maximum length greater than their media asset listings. For example, control circuitry 304 may generate for display indicator 510 such that its maximum length is the width of the media asset listings for “Friends,” “Will & Grace,” and “ER” combined.

Although only horizontal indicators are shown, it is understood that any shape of indicators may be used in electronic program guide 500. In some embodiments, the interactive media guide may display text with indicators. For example, control circuitry 304 may generate for display text with the indicators to indicate the length of advertisements remaining, such as “00:30 seconds” or “25% remaining.” Control circuitry 304 may also generate for display text to indicate whether the indicator represents currently displaying or future media assets. In some embodiments, the interactive media guide may generate for display different indicators of different shapes, colors, or sizes to indicate this information as well.

FIG. 6 shows an exemplary electronic program guide that may be generated by the interactive media guide on display 312. Electronic program guide 600 may be similar to the electronic program guide discussed in relation to FIG. 2.

Indicators 602, 606, and 612 may be similar to indicators 508, 510, and 512 discussed above in relation to FIG. 5. For example, control circuitry 304 may generate for display the indicators such that indicator 612 is shorter than indicator 602. This may indicate that media asset “Goldfish” 610 includes a shorter length of advertisements than media asset “Kitten” 604.

Electronic program guide 600 may display media asset listings for on-demand program assets. Electronic program guide 600 depicts three media asset listings for media assets “Kitten” 604, “Puppy” 608, and “Goldfish” 610. Electronic program guide 600 also depicts three indicators 602, 606, and 612 associated with each of these media assets.

In some embodiments, on-demand media assets may display all their advertisements before the on-demand media asset is presented. In some embodiments, on-demand media assets may display their advertisements in breaks during the presentation of the on-demand media assets. The interactive media guide may generate for display visually distinguishing characteristics such as different shapes, sizes, or colors of indicators to represent this difference. For example, control circuitry 304 may generate for display arrows on the ends of indicator 602 to indicate that media asset “Kitten” 604 includes advertisements in breaks during the media asset. Control circuitry 304 may generate for display no arrows on the ends of indicators 606 and 612 to indicate that their respective media assets “Puppy” 608 and “Goldfish” 610 include advertisements at the beginning of the respective media asset.

In some embodiments, the interactive program guide may use indicators to indicate whether advertisements can be skipped or not. The interactive program guide may allow users to indicate whether they wish to skip an advertisement. In some embodiments, the interactive program guide may only allow users to indicate whether they wish to skip an advertisement after they have viewed a threshold amount of the advertisement. For example, control circuitry 304 may display indicator 606 such that half the indicator consists of a dashed line and the other half consists of a solid line. This may indicate that the advertisements in media asset “Puppy” 608 can be skipped. In some embodiments, the ratio of dashed to solid lines may indicate what the ratio of the length of advertisements that must be watched to the length of the advertisements that can be skipped. For example, indicator 606 may indicate that half of the advertisements in media asset “Puppy” 608 can be skipped.

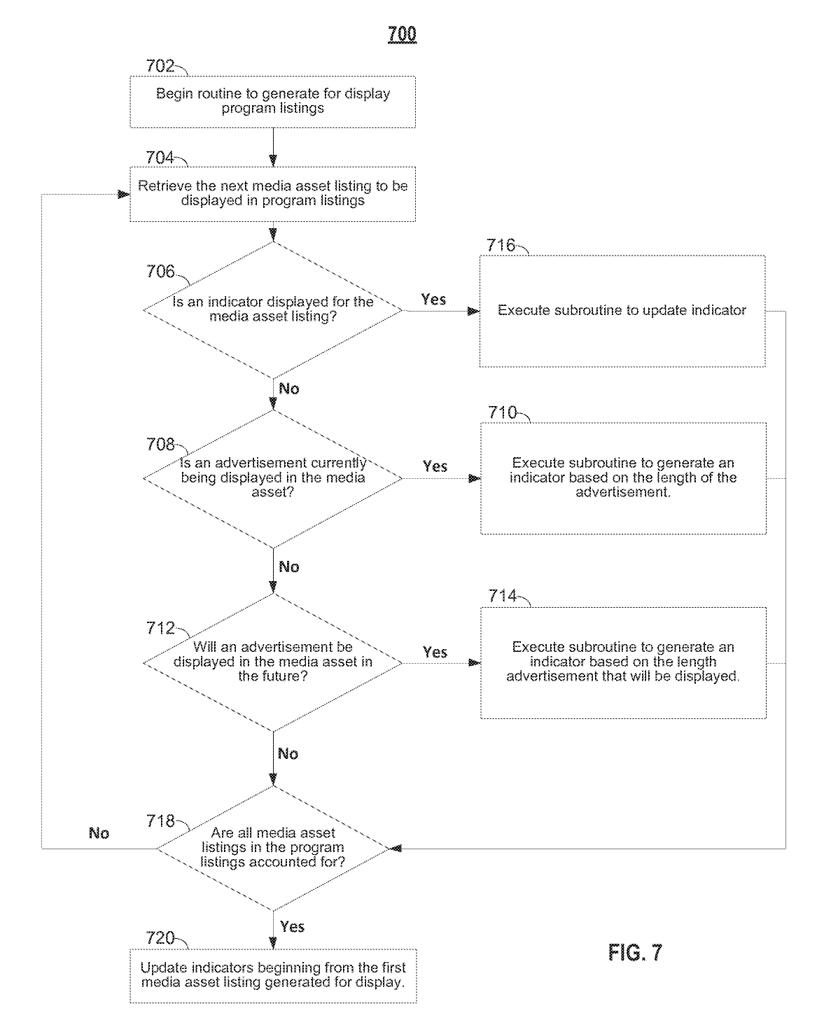

FIGS. 7, 8, 9, and 10 present processes for control circuitry (e.g., control circuitry 304) to determine advertisement length and generate for display indicators in accordance with some embodiments of the disclosure. In some embodiments these processes may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

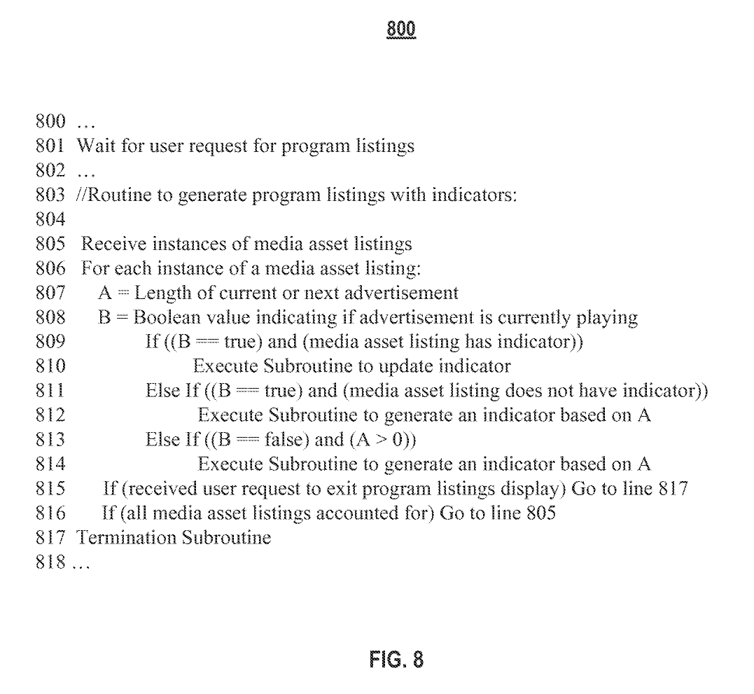

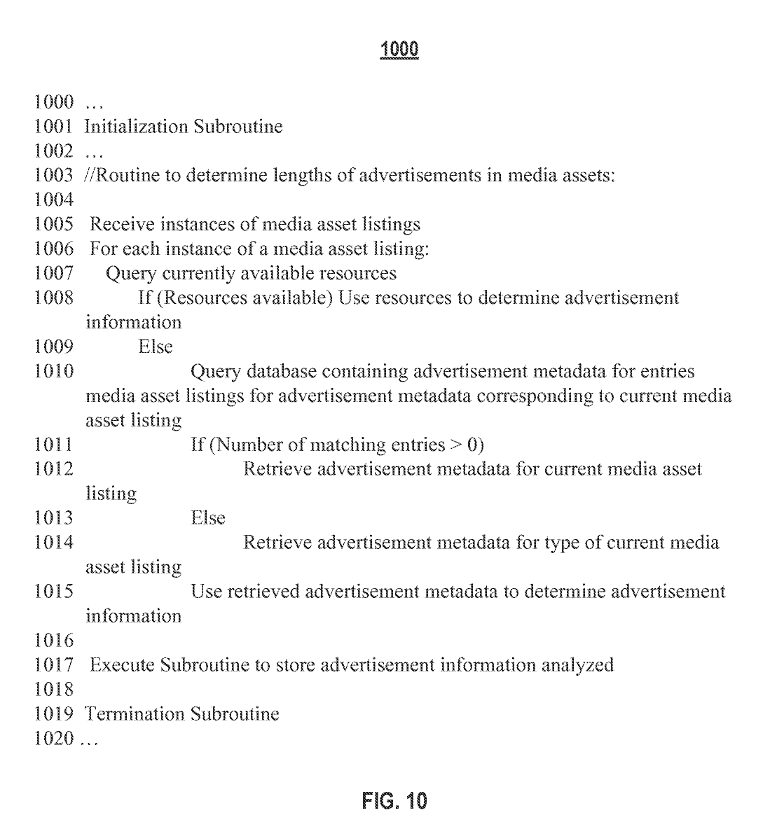

It will be evident to one skilled in the art that the processes described by the pseudocode in FIGS. 8 and 10 may be implemented in any number of programming languages and a variety of different hardware, and the particular choice and location of primitive functions, logical evaluations, and function evaluations are not intended to be limiting. It will also be evident that the pseudocode may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed in pseudocode 800 or 1000 to speed operation, or the conditional statements may be replaced with a case-switch. In some embodiments, rather than iterating over all instances of media assets, in some embodiments the pseudocode may be rewritten so control circuitry 304 is instructed to evaluate multiple instances of media assets simultaneously on a plurality of processors or processor threads, lowering the number of iterations needed and potentially speeding up computation time.

FIG. 7 shows an illustrative process 700 for generating media asset listings as shown in FIGS. 1, 2, 5, and 6. Process 700 may be used by the interactive media guide to generate both the media asset listings and their associated indicators.

Process 700 begins at block 702. At block 702, the interactive media guide begins the routine to generate for display program listings. In some embodiments, the interactive media guide may begin the routine in response to receiving a user request through user input interface 310 to display electronic media guide 500 or 600. In some embodiments, the interactive media guide may begin the routine at predetermined intervals. The interactive media guide may perform process 700 before, or during, presenting electronic program guide 500 or 600.

Process 700 continues to block 704. At block 704, the interactive media guide retrieves, using storage circuitry 308, the next media asset listing to be displayed in the program listings. If block 704 has been reached for the first time, control circuitry 304 may retrieve an arbitrary media listing to be the first listing. If block 704 has not been reached for the first time, control circuitry 304 may retrieve any program listing that has not been retrieved earlier in process 700. Media asset listings that are retrieved by process 700 may be marked or tagged to distinguish them from those that have not yet been retrieved. The program listings of electronic program guide 500 or 600 may be stored in a cache using storage circuitry 308. When a user changes the program listings currently displayed in electronic program guide 500 or 600, for example, by scrolling through the electronic program guides, the program listings used in process 700 may be updated by control circuitry 304 to only include those program listings currently being displayed.

Process 700 continues to block 706. At block 706, the interactive media guide determines whether an indicator is currently displayed for the media asset listing. The indicator may have been created for the media asset in a previous iteration of process 700. In some embodiments, each media asset listing may be associated with a data structure that lists information about that media asset listing, such as whether an indicator is currently displayed for that media asset listing. This data structure may be stored using storage circuitry 308. If an indicator is currently being displayed for the media asset listing, process 700 continues to block 716. If an indicator is not currently displayed for the media asset listing, process 700 continues to block 708.

At block 716, the interactive media guide executes a subroutine to update the indicator. The data structure for the corresponding media asset listing may include information about the previous time the indicator was updated. Control circuitry 304 may retrieve the previous time the indicator was updated. Control circuitry 304 may also retrieve a current time. Control circuitry 304 may then determine a difference between these two times. If the difference is greater than a predetermined threshold time interval, control circuitry 304 may update the associated indicator. For example, an indicator may indicate that 30 seconds of advertisements remain in the associated media asset. Control circuitry 304 may retrieve the data structure associated with the media asset using storage circuitry 308. The data structure may indicate that the indicator was previously updated at 21:42:35. Control circuitry 304 may retrieve the current time, which is 21:42:50. Control circuitry 304 may determine the difference between these times is 00:00:15, or fifteen seconds. Control circuitry 304 may compare the difference of fifteen seconds to the threshold predetermined time interval of ten seconds, which requires that indicators should be updated if they have not been updated in the last ten seconds. Control circuitry 304 may hence determine that the indicator should be updated. Control circuitry 304 may update the indicator by reducing the length of the indicator to indicate fifteen seconds have passed. Hence, the updated indicator may indicate that 15 seconds of advertisements remain in the associated media asset.

In some embodiments, the user may be able to modify a default value of the threshold time interval to update the indicators with more or less frequency. In some embodiments, control circuitry 304 may update the indicator by removing the indicator to indicate that no advertisements are being displayed in the associated media asset. Control circuitry 304 may then update the previous time the indicator was updated stored in the data structure stored with the media asset listing.

At block 708, the interactive media guide determines whether an advertisement is currently being displayed in the media asset. A variety of methods may be used to make this determination. In some embodiments, control circuitry 304 may determine if an advertisement is currently being displayed in a broadcast media asset by using a spare tuner to tune to the media asset. Control circuitry 304 may poll all available tuners in a user device such as user television equipment 402 to determine which tuners are not currently being used for tasks such as watching a broadcast show or recording a broadcast show. Control circuitry 304 may use available tuners to access each available media asset for a predetermined amount of time.

Control circuitry 304 may then use heuristics to determine if an advertisement is currently being displayed. For example, a higher than average volume level, a black screen, or certain known images may indicate the presence of an advertisement. As referred to herein, “black screen” refers to any screen marking a transition between a media asset and an advertisement. For example, control circuitry 304 may determine a tuner in user television equipment 402 is not being used, and may use this tuner to tune to all available channels for five second periods. Control circuitry 304 may perform this tuning operation in the background in a manner invisible to a user. Control circuitry 304 may determine an average volume level for each channel. Control circuitry 304 may determine that channels with a volume level less than a threshold volume level are displaying media assets, while channels with a volume level more than a threshold volume level are displaying advertisements. Control circuitry 304 may also determine that a black screen is currently being generated for display, indicating a transition between a media asset and an advertisement, or between two advertisements.

Control circuitry 304 may also analyze received frames of videos to determine if known logos or products appear in them. For example, control circuitry 304 may compare an incoming frame of a broadcast media asset to a database of commonly used advertising logos to determine that an incoming frame matches the “Coca-Cola” logo. Hence, control circuitry 304 may determine the incoming frame is part of an advertisement. Any combination of these heuristics may be used to determine whether an advertisement is currently being displayed. Control circuitry 304 may determine an advertisement begins when it determines an advertisement is being displayed for a media asset where in a previous iteration a media asset was being displayed. Control circuitry 304 may determine an advertisement ends when it determines an advertisement is no longer being displayed for a media asset where in a previous iteration an advertisement was being displayed.

In some embodiments, control circuitry 304 may use a spare user computer equipment 404 to access an entire on-demand media asset, and determine lengths advertisements. For example, user computer equipment 404 may access videos available from an Internet video website such as “YouTube” to determine information about the advertisements that play before and during the videos. User computer equipment 404 may use heuristics such as not being able to skip or forward a video, or being shown an opportunity to click a link for more information to determine that an advertisement is currently playing. In addition, user computer equipment 404 may also use any of the heuristics described above to determine when an advertisement is playing.

In some embodiments, control circuitry 304 may use metadata associated with the media assets to determine whether an advertisement is currently being displayed. For example, control circuitry 304 may retrieve metadata for the media asset associated with the current media asset listing from media guidance data source 418 using communications network 414. The metadata may indicate times when advertisements will begin and end for the media asset. The interactive media guide may retrieve a current time, and compare the current time to the times given in the metadata to determine whether an advertisement is currently being displayed. In some embodiments, control circuitry 304 may retrieve metadata associated with a type of the media asset instead of the media asset. For example, control circuitry 304 may retrieve metadata associated with a type of the media asset if metadata for a specific media asset is not available. A type of the media asset may include a genre of the media asset (e.g., comedy, romance, drama), actors, directors, or crew members associated with the media asset (e.g., Tom Cruise, Nicole Kidman, Steven Spielberg), a source of the media asset (e.g., Comedy Channel, Universal Studios, Netflix), a time of the media asset (e.g., broadcast at 7:00 pm, primetime, released in 1976), or any such categorization attribute. Metadata associated with the type of the media asset may be a good estimate for metadata associated with the media asset itself.

Interactive media guidance application may store information about whether an advertisement is currently being displayed, when the advertisements began, and when they will end, using storage circuitry 308. This information may be stored in the data structure associated with the media asset, as described above. This information may be used in blocks 710, 712, and 714 as described bellow.

If the interactive media guide determines an advertisement is currently being displayed, process 700 proceeds to block 710. If the interactive media guide determines an advertisement is not currently being displayed, process 700 proceeds to block 712. At block 710, the interactive media guide executes a subroutine to generate for display indicators as described in relation to electronic program guides 500 and 600. In some embodiments, the interactive media guide may also disable highlighting or selection of the media asset listing.

To generate an indicator, the interactive program guide may retrieve determined or approximated a beginning and end of advertisements as stored during the determination of block 708. Control circuitry 304 may determine a length of the advertisements by subtracting the time of the end of the advertisements from the time of the beginning of the advertisements. Control circuitry 304 may use this length to generate an indicator of the appropriate length. In some embodiments, control circuitry 304 may further send information about determined advertisement lengths to media guidance data source 418, where it can be used to determine advertisement information for different types of media assets.

At block 712, the interactive media guide determines whether an advertisement, or a series of advertisements, will be displayed in the media asset in the future. This may be done using metadata about the media asset, as described in relation to block 708. If the interactive media guide determines that an advertisement will be displayed in the media asset in the future, process 700 proceeds to step 714. If the interactive media guide determines that an advertisement will not be displayed in the media asset in the future, process 700 proceeds to step 718. In some embodiments, process 700 only proceeds to block 714 if an advertisement will be displayed in the future within a threshold amount of time. Control circuitry 304 may allow a user to modify this threshold of time using user input interface 310 to enter a value. For example, control circuitry 304 may determine an advertisement will be displayed in the future only if the advertisement will be displayed in the next minute.

At block 714, the interactive media guide executes a subroutine to generate for display an indicator based on the length of the advertisement that will be displayed in the future. Control circuitry 304 may generate this advertisement in a manner similar to that described in relation to block 710. In some embodiments, control circuitry 304 may distinguish the indicators indicating future advertisements from the indicators indicating currently displayed advertisements. For example, control circuitry 304 may distinguish the indicators indicating future advertisements by adding text to them, or displaying them in a different shape, size, or color than indicators indicating currently displayed advertisements. The interactive media guide may generate for display the indicators for future advertisements simultaneously or alternatively with the indicators for currently displayed advertisements.

After executing blocks 716, 710, or 714, process 700 proceeds to block 718. At block 718, the interactive media guide determines if all media assets in the program listings are accounted for. If control circuitry 304 determines that some media assets have not yet been processed using process 700, process 700 returns to block 704. In some embodiments, control circuitry 304 may determine all media assets are not accounted for if the data structure associated with at least one media asset indicates it has not been processed with process 700. In some embodiments, control circuitry 304 may determine all media assets are not accounted for if a user request to modify the program listings currently displayed, for example, through scrolling through them, is received from user input interface 310. In some embodiments, control circuitry 304 may store all program listings in a data structure such as an array, and determine all media assets are not account for if at least one element of the array has not yet been accessed.

Process 700 proceeds to block 720. At block 720, the interactive media guide updates indicators beginning from the first indicator generated for display. In other words, control circuitry 304 repeats process 700 starting from block 702. In some embodiments, this is only done at predetermined intervals of time. In some embodiments, this is done every time block 720 is reached. In some embodiments, if control circuitry 304 receives a user request to exit the program listings display from user input interface 310, control circuitry 304 may terminate process 700 at any block in process 700.

FIG. 8 shows for display illustrative pseudocode that may execute process 700 for generating media asset listings. Pseudocode 800 may be executed on any user device, and may be written in any language or combination of languages. Pseudocode 800 may be executed in a sequential or parallel fashion. Pseudocode 800 may include instructions other than those shown, for instance in lines 800, 802, 804, 805 and/or 818. It will be evident to one skilled in the art that the algorithm described by the pseudocode in FIG. 8 may be implemented in any number of programming languages and a variety of different hardware, and that the style and format should not be construed as limiting, but rather a general template of the steps and procedures that would be consistent with pseudocode used to implement some embodiments of this disclosure.

Pseudocode 800 begins at line 801, which may implement block 702. At line 801, the interactive media guide waits for a user request for program listings through user input interface 310. For example, control circuitry 304 may receive a user request to view electronic program guide 500 or 600. In some embodiments the interactive media guide may wait for a predetermined amount of time to pass since the last iteration of pseudocode 800 was performed.

Pseudocode 800 proceeds to line 803. At line 803, the interactive program guide takes no action, as line 803 merely contains a comment to describe the function of pseudocode 800 and make the pseudocode easier to comprehend for humans.

Pseudocode 800 proceeds to line 805. At line 805, the interactive program guide receives instances of media asset listings. For example, control circuitry 304 may retrieve data structures corresponding to currently displayed media asset listings using storage circuitry 308, or from media guidance data source 418. In some embodiments, control circuitry 304 may retrieve data structures for more media asset listings than those currently being displayed. For example, control circuitry 304 may determine which media asset listings are not being displayed, but are adjacent to those media asset listings currently being displayed. Control circuitry 304 may retrieve data structures for these media asset listings too, as there is a chance the user may scroll to these media asset listings in the future.

Pseudocode 800 proceeds to line 805. At line 805, the interactive program guide iterates through each instance of the media guide listings received in line 805, to execute block 704. For each media asset listing, pseudocode 800 performs the instructions described in lines 807 to 816 inclusive.

At line 807, the interactive media guide determines a length of a current or next advertisement. In some embodiments, control circuitry 304 may determine the length of a current advertisement by default, and determine the length of a next advertisement if the length of a current advertisement is not being displayed. In some embodiments, the interactive media guide may determine the length of an entire advertisement break instead of a single advertisement. For example, control circuitry 304 may determine the length of each advertisement in an advertisement break, and add the lengths of time together to determine the length of the advertisement break.

At line 808, the interactive media guide determines whether an advertisement is currently playing, and stores this determination as a “true” or “false” Boolean value. Lines 807 and 808 may be implemented to perform any of the methods of determination described in relation to block 708.

At line 809, the interactive media guide determines whether an advertisement is currently being displayed and whether the media asset listing already has an indicator. This may be done as described in relation to block 706. If control circuitry 304 determines the conditions in line 809 are both true, pseudocode 800 proceeds to line 810.

At line 810, control circuitry executes a subroutine as described in relation to block 716 to update the displayed indicator and proceeds to line 811. If control circuitry 304 determines at least one condition in line 809 is false, pseudocode 800 proceeds to line 811. In some embodiments control circuitry 304 may further determine if an advertisement is not currently playing and the media asset listing has an indicator. If so, control circuitry 304 may remove the indicator from being generated for display on display 312, or modify the indicator to indicate the length of a future advertisement.

At line 811, the interactive media guide determines if an advertisement is currently playing and the media asset listing does not have an indicator. If control circuitry 304 determines all conditions in line 811 are true, pseudocode 800 proceeds to line 812. At line 812, the interactive media guide executes a subroutine to generate for display an indicator based on the length of the current advertisement and process 800 proceeds to line 813. Control circuitry 304 may perform the subroutine of line 812 as described in relation to block 710. If control circuitry 304 determines at least one condition in line 811 is not true, process 800 proceeds to line 813.

At line 813, the interactive media guide determines if an advertisement is not being displayed, and a length of time is available for a future advertisement. This may be done as described in relation to block 712. If control circuitry 304 determines all conditions described in line 813 are true, pseudocode 800 proceeds to line 814. At line 814, control circuitry 304 executes a subroutine to generate an indicator based on a length of a future advertisement as described in relation to block 714 and pseudocode 800 proceeds to line 815. If control circuitry 304 determines at least one of the conditions described in line 814 is false, pseudocode 800 proceeds to line 815.

At line 815, the interactive media guide determines if a user request to exit electronic program guide 500 or 600 through user input interface 310. If control circuitry 304 determines such a user request was received during execution of lines 805 to 816, pseudocode 800 proceeds to line 817, terminating the loop described in lines 806 to 816.

At line 816, the interactive media guide determines if all media asset listings currently being displayed in electronic program guide 500 or 600 have been accounted for. For example, if a user request to scroll through electronic program guide 500 or 600 was received by control circuitry 304 through user input interface 310 after the execution of line 805, then control circuitry 304 may determine that the media asset listings retrieved in line 805 do not match the media asset listings currently being displayed on screen. Pseudocode 800 may proceed to line 805, and control circuitry 304 may repeat the loop described in lines 806 to 814 with a different instance of media asset listings corresponding to the currently displayed media asset listings.

At line 817, the interactive media guide performs a termination subroutine. In some embodiments, the termination subroutine may include control circuitry 304 using storage circuitry 308 to update data structures associated with each of the media asset listings. Control circuitry 308 may update the data structures to store information about the length of the current or next advertisement for each media asset listing, whether an advertisement is currently playing in each media asset listing, whether each media asset listing is associated with an indicator and the visual characteristics of any such indicator.

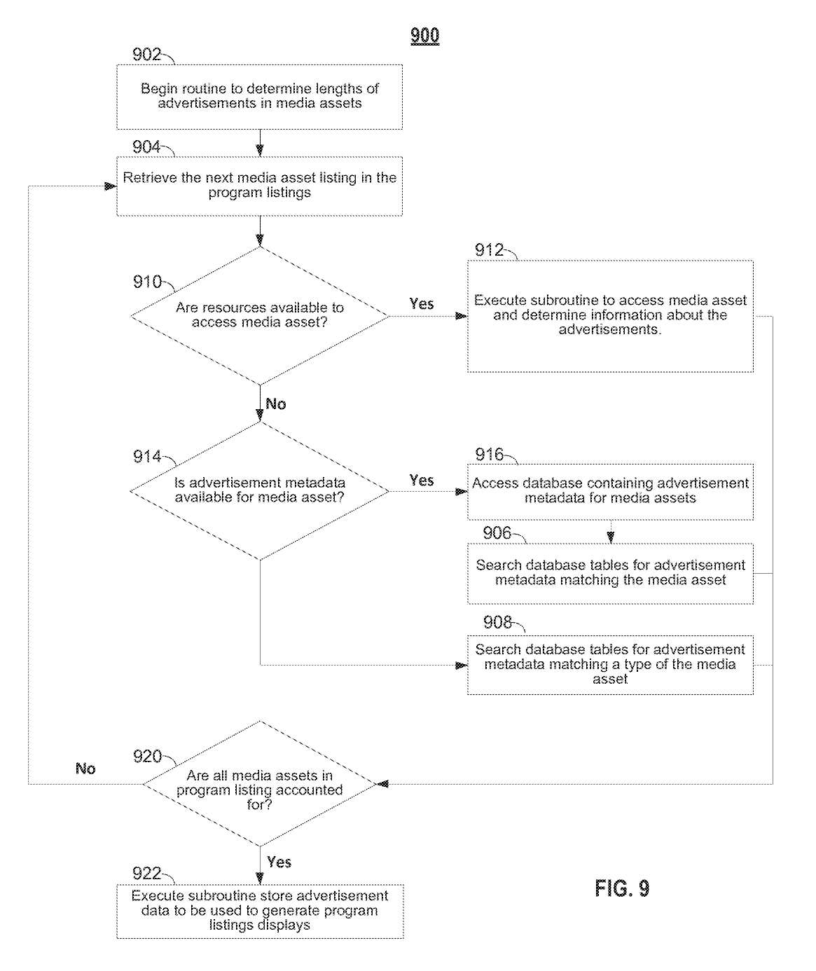

FIG. 9 is an illustrative process 900 to determine lengths of advertisements in media assets. Process 900 begins at block 902. At block 902, the interactive media guide begins a routine to determine lengths of advertisements in media assets. In some embodiments, control circuitry 304 may begin process 900 in response to a user request received through user input interface 310. For example, if control circuitry 304 receives a user request to display electronic program guide 500 or 600, control circuitry 304 may begin process 900. In some embodiments, control circuitry 304 may begin process 900 in response to determining that a predetermined amount of time has passed since the previous time when process 900 was executed.

Process 900 proceeds to block 904. At block 904, the interactive media guide retrieves the next media asset listing in the program listings. The interactive media guide may execute block 904 in a manner similar to that described in relation to block 704. Process 900 proceeds to block 910. At block 910, the interactive media guide determines whether resources are available to access the media asset. In some embodiments, if the media asset is a broadcast television program, control circuitry 304 may determine if user television equipment 402 has extra tuners that are not currently being used to tune to a channel being watched, or record a media asset. If control circuitry 304 determines extra tuners are available, process 900 may proceed to block 912. In some embodiments, if the media asset is an on-demand media asset, control circuitry 304 may determine if enough processing circuitry 306 includes enough computing power to access the media asset in a background operation. If control circuitry 304 determines sufficient computing power is available to do so, process 910 proceeds to block 912. If control circuitry 304 determines resources are not available to access the media asset, process 910 proceeds to block 914.

At block 912, the interactive media guide executes a subroutine to access the media asset and determine information about the advertisements. In some embodiments, the interactive media guide may access the entirety of the media asset to determine exact start and end points for each advertisement in the media asset. In some embodiments, the interactive media guide may access each media asset at predetermined time intervals, and determine whether an advertisement or a media asset is currently being displayed. The interactive media guide may then approximate the start or end points of advertisements in the media asset using this determination. For example, control circuitry 304 may access a media asset at times t=0 s, t=5 s, and t=10 s. Control circuitry 304 may determine an advertisement was being displayed at times t=0 s and t=5 s. Control circuitry 304 may determine a media asset was being displayed at time t=10 s. Hence, control circuitry 304 may estimate that an end time of advertisements for this media asset is time t=7.5 s by averaging times t=5 s and t=10 s. Control circuitry 304 may determine whether an advertisement or a media asset is currently being displayed using the techniques described in relation to block 708. Control circuitry 304 may then modify the data structure associated with the media asset, using storage circuitry 308, to include this information about advertisements in the media asset.

At block 914, the interactive media guide executes a subroutine to determine if advertisement metadata is available for the media asset. In some embodiments, the advertisement metadata may include information about whether an advertisement exists for the media asset, and if so, its start and end times. Advertisement metadata may be available from media guidance data source 418. If control circuitry 304 determines advertisement metadata is available, process 900 proceeds to block 916. If control circuitry 304 determines advertisement metadata is not available, process 900 proceeds to block 908.

At block 916, the interactive media guide executes a subroutine to access a database containing advertisement metadata for the media asset. For example, control circuitry may request the advertisement metadata from media guidance data source 418 using communications network 414. The database may include listings of media asset identifiers and their associated advertisement metadata. Process 900 then proceeds to block 906. The interactive media guide searches database tables for advertisement metadata matching the media asset. Control circuitry 304 may perform the search by cross-referencing an identifier of the current media asset with the listings in the database. Control circuitry 304 may use the advertisement metadata found by the search to determine start and end times of advertisements in the media asset. In some embodiments, control circuitry 304 may consolidate data related to consecutive advertisements to determine start and end times of advertisement breaks. For example, if a first advertisement in an advertisement break begins at 10:00:00 am and ends at 10:00:30 am, and a second advertisement break begins at 10:00:31 am and ends at 10:01:31 am, control circuitry 304 may determine that the advertisement break begins at 10:00:00 am and ends at 10:01:31 am. Process 900 then proceeds to block 920.

It is also understood that although we may describe control circuitry 304 interacting with a single database, this is only a single embodiment described for illustrative purposes, and the algorithm of FIG. 9 may be implemented using multiple independent or cross-referenced databases. For example, a database stored locally (e.g., on storage 308) may index or cross-reference a database stored remotely (e.g., media guidance data source 418), which may be accessible through any number of communication channels (e.g., communications network 414). In some embodiments, this may allow control circuitry 304 to utilize a look-up table or database front-end efficiently stored on a small local drive to access a larger database stored on a remote server on demand.

At block 908, the interactive media guide searches the database advertisement metadata matching a type of the media asset. In some embodiments, control circuitry 304 may retrieve a different database listing types of media assets and their associated advertisement metadata from media guidance data source 418 through communications network 414. In some embodiments, control circuitry 304 may determine a type for the media asset and cross-reference an identifier of the type with the retrieved database. For example, control circuitry 304 may determine that advertisement metadata does not exist for a television game show program “Family Feud.” Control circuitry 304 may retrieve a database listing identifiers of genres of programs and their associated advertisement metadata from media guidance data source 418 through communications network 414. Control circuitry 304 may determine that a genre of “Family Feud” is “game show” by analyzing metadata associated with the media asset listing. Control circuitry 304 may cross-reference an identifier of the genre “game show” and find advertisement metadata indicating that game shows usually have three minute advertisement breaks after five minutes, fifteen minutes, and twenty five minutes of the game show start time. Control circuitry 304 may use the advertisement metadata to estimate advertisement start and end times for “Family Feud.” Process 900 then proceeds to block 920.

In some embodiments, if a type of the media asset cannot be found in the database, the interactive media guide may search the database for another type of the same media asset. For example, control circuitry 304 may determine that a type of a television game show program is “Family Feud” and a type of this program is a genre “game show”. Control circuitry 304 may search a database for advertisement metadata associated with an identifier of the genre “game show” and determine no such advertisement metadata exists. In response, control circuitry 304 may determine another type of the media asset “Family Feud” is “PG parental control rating” and use this type to search the database.

After executing blocks 912, 906, or 908, process 900 proceeds to block 920. At block 920, the interactive media guide determines if all media assets in the program listings are accounted for. Control circuitry 304 may perform this determination as described in relation to block 918. Process 900 then proceeds to block 922. At block 922, the interactive media guide executes a subroutine to store advertisement information to be used to generate program listings. Control circuitry 304 may store the advertisement information, including start and end times of advertisements for media asset listings in the program listings, using storage circuitry 308. In some embodiments, control circuitry 304 may also send the advertisement information to media guidance data source 418 through communications network 414, to be used in updating advertisement times for different types of media assets, and hence update the database that may be retrieved in block 908.

FIG. 10 shows for display illustrative pseudocode that may execute process 900 for generating media asset listings. Pseudocode 1000 may be executed on any user device, and may be written in any language or combination of languages. Pseudocode 1000 may be executed in a sequential or parallel fashion. Pseudocode 1000 may include instructions other than those shown, for instance in lines 1000, 1000, 1002, 1016, 1018, and/or 1020. It will be evident to one skilled in the art that the algorithm described by the pseudocode in FIG. 10 may be implemented in any number of programming languages and a variety of different hardware, and that the style and format should not be construed as limiting, but rather a general template of the steps and procedures that would be consistent with pseudocode used to implement some embodiments of this disclosure.

Pseudocode 1000 begins at line 1001. At line 1001, the interactive media guide begins an initialization subroutine. Control circuitry 304 may perform this initialization as described in relation to block 902. Pseudocode 1000 includes line 1003, which is included as a human-readable pseudocode comment, but does not perform any functions in the pseudocode.

Pseudocode 1000 proceeds to line 1005. At line 1005, the interactive media guide receives instances of media asset listings. Pseudocode 1000 then proceeds to line 1006. At line 1006, the interactive media guide begins a loop to execute the instructions in lines 1007 to 1015 for each received media asset listing. Control circuitry 304 may execute lines 1005 and 1006 in a similar manner to that described in relation to lines 805 and 806.

Pseudocode 1000 proceeds to line 1006. At line 1006, the interactive media guide queries currently available resources to determine if resources are available to access the media asset. Control circuitry 304 may query each available resource to determine whether it is available or busy. Control circuitry 304 may determine whether resources are available or busy as described in relation to block 910.

Pseudocode 1000 proceeds to line 1007. At line 1007, the interactive media guide results of the querying in line 1007 to determine whether resources are available. If resources are available, control circuitry uses the resources to determine advertisement information as described in relation to block 912. If resources are not available, the interactive media guide determines the condition in line 1009 is true, and executes the pseudocode in lines 1010 to 1015.

At line 1010, the interactive media guide queries a database containing identifiers of media assets and their associated advertisement metadata. Control circuitry 304 may perform the querying as described in relation to block 914. If control circuitry 304 determines that advertisement metadata associated with the current media asset listing is available, control circuitry 304 determines the condition in line 1011 is true and pseudocode 1000 proceeds to line 1012. If control circuitry 304 determines that advertisement metadata associated with the current media asset listing is not available, control circuitry determines the condition in line 1013 is true and pseudocode 1000 proceeds to line 1014.

At line 1012, control circuitry 304 retrieves advertisement metadata for the current media asset listing. Control circuitry 304 may retrieve the advertisement metadata as described in relation to blocks 916 and 906. At line 1014, control circuitry 304 may retrieve advertisement metadata for the type of current media asset listing. Control circuitry 304 may retrieve advertisement metadata for the type of current media asset listing as described in relation to block 908.

After either line 1012 or line 1014 has been executed, pseudocode 1000 proceeds to line 1015. At line 1015, the interactive media guide uses the retrieved advertisement metadata to determine advertisement information. Control circuitry 304 may use the retrieved advertisement metadata to determine start and end times of advertisements, and use the start and end times of advertisements to determine advertisement lengths. Control circuitry 304 may perform determination as described in relation to blocks 906 and 908.

Pseudocode 1000 proceeds to line 1017. At line 1017, the interactive media guide executes a subroutine to store advertisement information determined in line 1015 in all iterations of the loop in line 1006. Control circuitry 304 may use storage circuitry 308 to store the advertisement information. In some embodiments, control circuitry 304 may store the advertisement information in a database of data structures associated with different media asset identifiers. Control circuitry 304 may use the stored advertisement information to generate indicators as described in relation to electronic program guides 500 and 600.

Pseudocode 1000 proceeds to line 1019. At line 1019, control circuitry 304 performs a termination subroutine to end and exit the subroutine described in pseudocode 1000.

It will be evident to one skilled in the art that the algorithm described by the pseudocode in FIG. 10 may be implemented in any number of programming languages and a variety of different hardware, and the particular choice and location of primitive functions, logical evaluations, and function evaluations are not intended to be limiting. It will also be evident that the pseudocode may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments the pseudocode may be re-written so control circuitry 304 is instructed to evaluate multiple instances of media assets and submit multiple database queries simultaneously using a plurality of processors or processor threads.

It is also understood that although we may describe control circuitry 304 interacting with a single database, this is only a single embodiment described for illustrative purposes, and the algorithm of FIG. 10 may be implemented using multiple independent or cross-referenced databases. For example, a database stored locally (e.g., on storage 308) may index or cross-reference a database stored remotely (e.g., media guidance data source 418), which may be accessible through any number of communication channels (e.g., communications network 414). In some embodiments, this may allow control circuitry 304 to utilize a look-up table or database front-end efficiently stored on a small local drive to access a larger database stored on a remote server on demand.

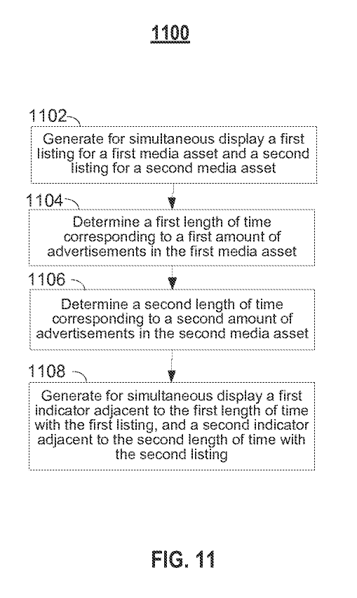

FIG. 11 shows an exemplary process for indicating commercial breaks in program guides. Process 1100 may result in a display of electronic program guides 500 or 600. Control circuitry 304 may perform any of processes 700 or 900 as part of performing process 1100.

Process 1100 begins at block 1102. At block 1102, control circuitry 304 generates for display on user display 312 an electronic program guide as shown in FIG. 1 or 2. Control circuitry 304 may generate for display the electronic program guide on any of user television equipment 402, user computer equipment 404, or wireless user communications device 406. For example, control circuitry 304 may generate for display media asset listings for two television programs “Dora the Explorer” and “Arthur.”

Process 1100 proceeds to blocks 1104 and 1106. At block 1104, control circuitry 304 determines a first length of time corresponding to a first amount of advertisements in the first media asset. Control circuitry may perform process 800 as implemented in pseudocode 900 to determine the first length of time. In some embodiments, the first amount of advertisements may be all advertisements in an advertisement break that appear consecutively without being interrupted by a media asset. In some embodiments, the advertisements in the first amount of advertisements may be overlaid, or displayed simultaneously with the media asset.

At block 1106, control circuitry 304 determines a second length of time corresponding to a second amount of advertisements in the second media asset. Control circuitry 304 may execute blocks 1104 and 1106 in parallel or sequentially. For example, control circuitry 304 may determine that the television program “Dora the Explorer” is currently displaying advertisements, and has two minutes of advertisements left to display. Control circuitry 304 may then determine that television program “Arthur” will display three minutes of advertisements in one minute.

Process 1100 proceeds to block 1108. At block 1108, control circuitry 304 generates for simultaneous display a first indicator adjacent to the first length of time with the first listing, and a second indicator adjacent to the second length of time with the second listing. Control circuitry 304 may update the display of block 1102 to an electronic program guide as discussed in relation to FIGS. 5 and 6. For example, control circuitry 304 may generate for display an indicator for the media asset listing for television program “Dora the Explorer” that indicates two minutes of advertisements are remaining. Control circuitry 304 may simultaneously generate for display an indicator for the media asset listing for television program “Arthur” that indicates advertisements will soon be beginning.

It should be noted that processes 700, 900, or 1100, or any step thereof could be performed on, or provided by, the optimization system on any of the devices shown in FIGS. 3-4. For example, processes 700, 800, or 1100 may be executed by processing circuitry 304 (FIG.3) as instructed by processing circuitry implemented on user equipment 402, 404, and/or 406 (FIG. 4) in order to provide information to a user. In addition, one or more steps of processes 700, 800, or 1100 may be incorporated into or combined with one or more steps of any other process or embodiment.

It is contemplated that the steps or descriptions of FIGS. 7-11 may be used with any other embodiment of this disclosure. In addition, the steps and descriptions described in relation to FIGS. 7-11 may be done in alternative orders or in parallel to further the purposes of this disclosure. For example, each of these steps may be performed in any order or in parallel or substantially simultaneously to reduce lag or increase the speed of the system or method.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for indicating commercial breaks in program guides, the method comprising:
generating for simultaneous display a first listing for a first media asset and a second listing for a second media asset;
determining a first length of time corresponding to a first amount of advertisements in the first media asset, wherein a first one of the advertisements in the first media asset is scheduled to begin playing at a play position later than a current play position of the first media asset;
determining a second length of time corresponding to a second amount of advertisements in the second media asset; and
generating for simultaneous display a first indicator representing the first length of time with the first listing, and a second indicator representing the second length of time with the second listing, wherein the first indicator is displayed before the first advertisement is scheduled to begin playing.

2. The method of claim 1, further comprising:
retrieving a previous update time of the first indicator;
retrieving a current time;
determining a difference between the current time and the previous update time of the first indicator;
determining if the difference is greater than a predetermined time interval; and
updating the first indicator in response to determining that the difference is greater than the predetermined time interval.

3. The method of claim 1, further comprising:
determining whether the advertisements in the first media asset can be skipped; and
updating, in response to determining that the advertisements in the first media asset can be skipped, the first indicator to indicate that the advertisements in the first media asset can be skipped.

4. The method of claim 1, further comprising:
determining whether the advertisements in the first media asset appear before or during the first media asset;
updating, in response to determining that the advertisements in the first media asset appear before the first media asset, the first indicator to indicate that the advertisements in the first media asset appear before the first media asset; and
updating, in response to determining that the advertisements in the first media asset appear during the first media asset, the first indicator to indicate that the advertisements in the first media asset appear during the first media asset.

5. The method of claim 1, wherein determining the first length of time further comprises:
detecting a beginning of playback of the advertisements in the first media asset;
detecting an end of playback of the advertisements in the first media asset; and
calculating the first length of time corresponding to a time difference between the end of playback of the advertisements in the first media asset and the beginning of playback of the advertisements in the first media asset.

6. The method of claim 5, wherein detecting the beginning of the playback and detecting the end of the playback of the advertisements in the first media asset further comprises:
accessing the first media asset for a predetermined length of time;
determining, during the predetermined length of time, an average volume level of the first media asset;
comparing the average volume level of the first media asset to a threshold volume level;
detecting the beginning of the playback of the advertisements in the first media asset when the average volume level is greater than the threshold volume level; and
detecting the end of the playback of the advertisements in the first media asset when the average volume level is less than the threshold volume level.

7. The method of claim 5, further comprising:
receiving a user selection of the first listing indicating a desire to access the first media asset;
retrieving a current time;
determining that the current time is after the beginning of the playback but before the end of the playback of the advertisements in the first media asset; and
ignoring, in response to the determination, the user selection.

8. The method of claim 1, wherein determining the first length of time further comprises:
determining a type of the first media asset; and
retrieving, from a database listing a plurality of lengths of time associated with a plurality of types of media assets, a length of time associated with the type of the first media asset by comparing the type of the first media asset to listings in the database.

9. The method of claim 1, wherein determining the first length of time further comprises:
retrieving, from a database listing a plurality of metadata associated with a plurality of media assets, metadata associated with the first media asset;
searching the metadata corresponding to the first media asset for values associated with lengths of time of the advertisements in the first media asset; and
calculating the first length of time by adding the values associated with the lengths of time of the advertisements in the first media asset.

10. The method of claim 1, further comprising:
retrieving, from a database listing a plurality of metadata associated with a plurality of media assets, metadata associated with the first media asset;
searching the metadata corresponding to the first media asset for values associated with a plurality of start times of the advertisements in the first media asset;
retrieving a current time;
determining if a difference between a start time of the plurality of start times and the current time is less than a predetermined length of time; and
updating, in response to determining that the difference is less than a predetermined length of time, the first indicator to indicate an advertisement will be beginning.

11. A system for indicating commercial breaks in program guides, the system comprising:
storage circuitry configured to store information corresponding to a plurality of media asset; and
control circuitry configured to:
generate for simultaneous display a first listing for a first media asset and a second listing for a second media asset;
determine, based on the stored information, a first length of time corresponding to a first amount of advertisements in the first media asset, wherein a first one of the advertisements in the first media asset is scheduled to begin playing at a play position later than a current play position of the first media asset;
determine a second length of time corresponding to a second amount of advertisements in the second media asset; and
generate for simultaneous display a first indicator representing the first length of time with the first listing, and a second indicator representing the second length of time with the second listing, wherein the first indicator is displayed before the first advertisement is scheduled to begin playing.

12. The system of claim 11, wherein the control circuitry is further configured to:
retrieve a previous update time of the first indicator;
retrieve a current time;
determine a difference between the current time and the previous update time of the first indicator;
determine if the difference is greater than a predetermined time interval; and
update the first indicator in response to determining that the difference is greater than the predetermined time interval.

13. The system of claim 11, wherein the control circuitry is further configured to:
determine whether the advertisements in the first media asset can be skipped; and
update, in response to determining that the advertisements in the first media asset can be skipped, the first indicator to indicate that the advertisements in the first media asset can be skipped.

14. The system of claim 11, wherein the control circuitry is further configured to:
determine whether the advertisements in the first media asset appear before or during the first media asset;
update, in response to determining that the advertisements in the first media asset appear before the first media asset, the first indicator to indicate that the advertisements in the first media asset appear before the first media asset; and
update, in response to determining that the advertisements in the first media asset appear during the first media asset, the first indicator to indicate that the advertisements in the first media asset appear during the first media asset.

15. The system of claim 11, wherein the control circuitry configured to determine the first length of time is further configured to:
detect a beginning of playback of the advertisements in the first media asset;
detect an end of playback of the advertisements in the first media asset; and
calculate the first length of time corresponding to a time difference between the end of playback of the advertisements in the first media asset and the beginning of playback of the advertisements in the first media asset.

16. The system of claim 15, wherein the control circuitry configured to detect the beginning of the playback and detect the end of the playback of the advertisements in the first media asset is further configured to:
access the first media asset for a predetermined length of time;
determine, during the predetermined length of time, an average volume level of the first media asset;
compare the average volume level of the first media asset to a threshold volume level;
detect the beginning of the playback of the advertisements in the first media asset when the average volume level is greater than the threshold volume level; and
detect the end of the playback of the advertisements in the first media asset when the average volume level is less than the threshold volume level.

17. The system of claim 15, wherein the control circuitry is further configured to:
receiving a user selection of the first listing indicating a desire to access the first media asset;
retrieving a current time;
determining that the current time is after the beginning of the playback but before the end of the playback of the advertisements in the first media asset; and
ignoring, in response to the determination, the user selection.

18. The system of claim 11, wherein the control circuitry configured to determine the first length of time is further configured to:
determine a type of the first media asset; and
retrieve, from a database listing a plurality of lengths of time associated with a plurality of types of media assets, a length of time associated with the type of the first media asset by comparing the type of the first media asset to listings in the database.

19. The system of claim 11, wherein the control circuitry configured to determine the first length of time is further configured to:
retrieve, from a database listing a plurality of metadata associated with a plurality of media assets, metadata associated with the first media asset;
search the metadata corresponding to the first media asset for values associated with lengths of time of the advertisements in the first media asset; and
calculate the first length of time by adding the values associated with the lengths of time of the advertisements in the first media asset.

20. The system of claim 11, wherein the control circuitry is further configured to:
retrieve, from a database listing a plurality of metadata associated with a plurality of media assets, metadata associated with the first media asset;
search the metadata corresponding to the first media asset for values associated with a plurality of start times of the advertisements in the first media asset;
retrieve a current time;
determine if a difference between a start time of the plurality of start times and the current time is less than a predetermined length of time; and
update, in response to determining that the difference is less than a predetermined length of time, the first indicator to indicate an advertisement will be beginning.

21-50. (canceled)
